(19) United States
(12) Patent Application Publication
(10) Pub. No.: US 2026/0145054 A1
(43) Pub. Date: May 28, 2026

(54) COMPUTER-IMPLEMENTED METHOD, GAME SYSTEM, AND ONE OR MORE NON-TRANSITORY COMPUTER-READABLE STORAGE MEDIA HAVING GAME PROGRAM STORED THEREIN

(71) Applicant: NINTENDO CO. LTD., Kyoto (JP)

(72) Inventors: Takahiro IWASAKI, Kyoto (JP); Yuma TAKENAGA, Kyoto (JP)

(21) Appl. No.: 19/370,146

(22) Filed: Oct. 27, 2025

(30) Foreign Application Priority Data
Nov. 26, 2024 (JP) 2024-205612

(51) Int. Cl. A63F 13/219; A63F 13/285

(52) U.S. Cl. CPC A63F 13/219; A63F 13/285

(57) ABSTRACT

A computer-implemented method includes: acquiring, from a first controller on which a mouse operation is performed by one hand of a user and which includes a first mouse sensor and a first vibration device, first data based on output of the first mouse sensor; control a virtual object, based on the first data; generating second data, based on a content of control of the virtual object; and vibrating a second vibration device of a second controller which is held by another hand of the user and includes the second vibration device, based on the second data.

### CROSS REFERENCE TO RELATED APPLICATION

This application claims priority to Japanese Patent Application No. 2024-205612 filed on Nov. 26, 2024, the entire contents of which are incorporated herein by reference.

### FIELD

The present disclosure relates to game processing for controlling a controller including a vibration device.

### BACKGROUND AND SUMMARY

Conventionally, controllers including vibration devices have been known.

There is room to provide users with novel game processing using a novel controller including a vibration device.

In view of the above point, for example, there are the following configuration examples.

### (Configuration 1)

Configuration 1 is directed to a computer-implemented method including:
acquiring, from a first controller on which a mouse operation is performed by one hand of a user and which includes a first mouse sensor and a first vibration device, first data based on output of the first mouse sensor;
controlling a position of a virtual object, based on the first data;
generating second data, based on the position of the virtual object; and
vibrating a second vibration device of a second controller which is held by another hand of the user and includes the second vibration device, based on the second data.

### (Configuration 2)

In Configuration 2 based on Configuration 1 above, the computer-implemented method may further include: acquiring third data based on output of a first direction input section which the first controller includes and which is configured to be operated by the user; controlling the position of the virtual object, based on the third data; generating fourth data, based on the position of the virtual object, at least while the virtual object is controlled based on the third data; and vibrating the first vibration device, based on the fourth data.

### (Configuration 3)

In Configuration 3 based on Configuration 1 or 2 above, the computer-implemented method may further include: acquiring fifth data based on output of an inertial sensor which the first controller includes; controlling the position of the virtual object, based on the fifth data; generating sixth data, based on the position of the virtual object, at least while the virtual object is controlled based on the fifth data; and vibrating the first vibration device, based on the sixth data.

### (Configuration 4)

In Configuration 4 based on any one of Configurations 1 to 3 above, the computer-implemented method may further include: acquiring seventh data based on output of a second direction input section which the first controller or the second controller includes and which is configured to be operated by the user; at least while the first controller and the second controller are directly or indirectly fixed to each other, controlling the position of the virtual object, based on the seventh data, and generating eighth data, based on the position of the virtual object; and vibrating the first vibration device and the second vibration device, based on the eighth data.

### (Configuration 5)

In Configuration 5 based on any one of Configurations 1 to 4 above, the computer-implemented method may further include generating the second data, based on a positional relationship between the virtual object and a first position.

### (Configuration 6)

In Configuration 6 based on any one of Configurations 1 to 5 above, the computer-implemented method may further include vibrating the second vibration device at a timing corresponding to a positional relationship between the virtual object and a first position.

### (Configuration 7)

In Configuration 7 based on any one of Configurations 1 to 6 above, there may be a second position different from the first position, attribute information associated with each of the first position and the second position is set, and the computer-implemented method may further include generating the second data such that the second vibration device is vibrated in a manner corresponding to the attribute information.

### (Configuration 8)

In Configuration 8 based on any one of Configurations 1 to 7 above, the computer-implemented method may further include generating the second data such that the second vibration device is vibrated in a manner corresponding to a positional relationship between the virtual object and the first position.

### (Configuration 9)

In Configuration 9 based on any one of Configurations 1 to 8 above, the computer-implemented method may further include: acquiring ninth data based on output of a third direction input section or a second button which the second controller includes and which is operated by the user; and performing predetermined game processing, based on the ninth data.

### BRIEF DESCRIPTION OF THE DRAWINGS

FIG. 1 shows a non-limiting example of a state in which a left controller 3 and a right controller 4 are attached to a main body apparatus 2;

FIG. 2 shows a non-limiting example of a state in which the main body apparatus 2, the left controller 3, and the right controller 4 are used as separate bodies;

FIG. 3 is six orthogonal views showing a non-limiting example of the left controller 3;

FIG. 4 is six orthogonal views showing a non-limiting example of the right controller 4;

FIG. 5 is a block diagram showing a non-limiting example of the internal configuration of the main body apparatus 2;

FIG. 6 is a block diagram showing a non-limiting example of the internal configurations of the main body apparatus 2, the right controller 3, and the left controller 4;

FIG. 7 shows a non-limiting example of a controller operation mode;

FIG. 8 shows a non-limiting example of a controller operation mode;

FIG. 9 shows a non-limiting example of a game screen;

FIG. 10 illustrates a non-limiting example of arrangement of treasures;

FIG. 11 shows a non-limiting example of various data stored in a DRAM 85 of the main body apparatus 2;

FIG. 12 shows a non-limiting example of the data structure of treasure-related data 603

FIG. 13 shows a non-limiting example of the data structure of operation data 612;

FIG. 14 is a non-limiting example of a flowchart showing the details of game processing;

FIG. 15 is a non-limiting example of a flowchart showing the details of an echo emission process;

FIG. 16 is a non-limiting example of a flowchart showing the details of an echo control process;

FIG. 17 is a non-limiting example of a flowchart showing the details of an excavation process;

FIG. 18 is a non-limiting example of a flowchart showing the details of a vibration control process; and

FIG. 19 shows a non-limiting example of a game screen in another exemplary embodiment.

### DETAILED DESCRIPTION OF NON-LIMITING EXAMPLE EMBODIMENTS

Hereinafter, an exemplary embodiment will be described.

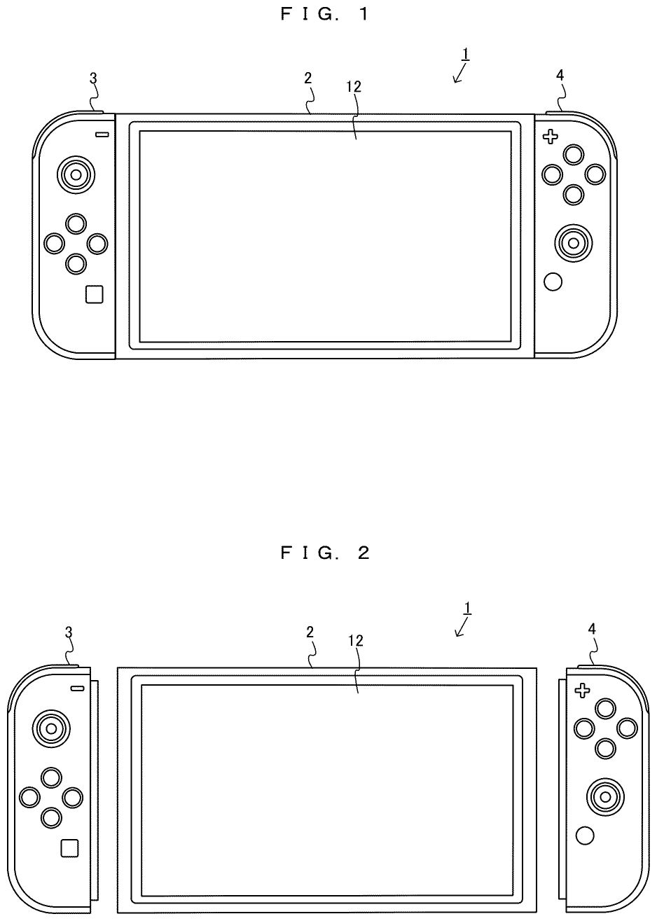

FIG. 1 shows an example of the appearance of a game system according to the exemplary embodiment. An example of a game system 1 according to the exemplary embodiment includes a main body apparatus (an information processing apparatus, which functions as a game apparatus main body in the exemplary embodiment) 2, which is an example of a computer, a left controller 3, and a right controller 4. Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2 as shown in FIG. 1. Further, in the game system 1, the main body apparatus 2, the left controller 3, and the right controller 4 can also be used as separate bodies as shown in FIG. 2. In the following description, the left controller 3 and the right controller 4 are collectively referred to as “controller”.

The main body apparatus 2 includes a display 12. The display 12 displays an image generated by the main body apparatus 2. The display 12 is a liquid crystal display device (LCD) as an example.

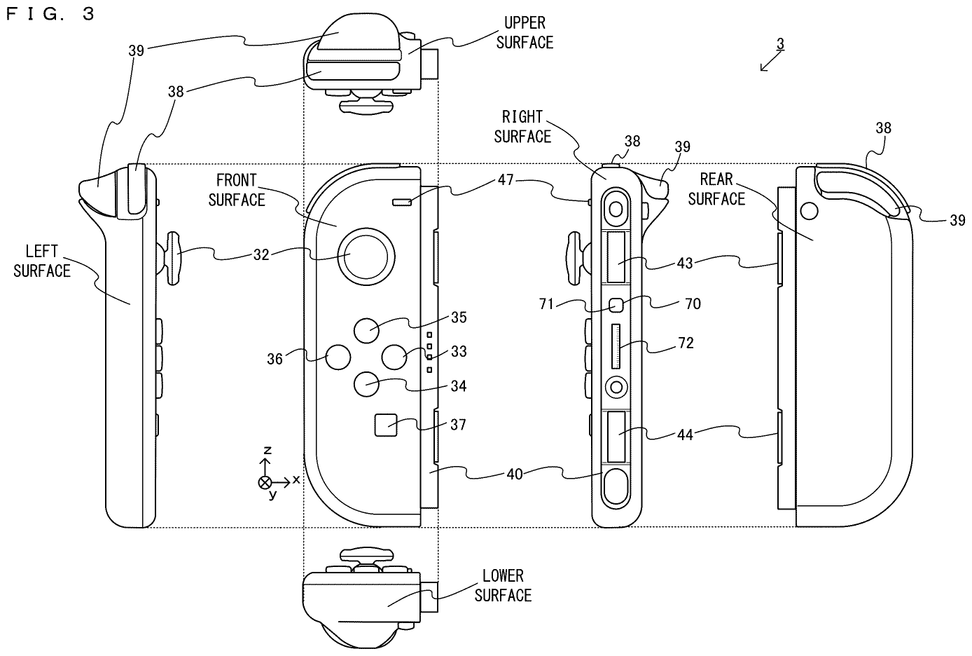

Next, the controller will be described. FIG. 3 is six orthogonal views showing an example of the left controller 3. As shown in FIG. 3, the left controller 3 has a vertically long shape, i.e., is shaped to be long in a z-axis direction shown in FIG. 3. The left controller 3 has a protruding portion 40 which is fitted into a recessed portion (not shown) of the main body apparatus 2 in a state where the left controller 3 is attached to the main body apparatus 2. In the state where the left controller 3 is detached from the main body apparatus 2, the left controller 3 can also be held in the orientation in which the left controller 3 is vertically long. The left controller 3 has such a shape and a size that when held in the orientation in which the left controller 3 is vertically long, the left controller 3 can be held with one hand, particularly, the left hand. Further, the left controller 3 can also be held in the orientation in which the left controller 3 is horizontally long. When held in the orientation in which the left controller 3 is horizontally long, the left controller 3 may be held with both hands.

The left controller 3 includes a left analog stick (hereinafter sometimes referred to as a “left stick”) 32 as an example of a direction input device. As shown in FIG. 3, the left stick 32 is provided on the front surface of the left controller 3. The left stick 32 can be used as a direction input section with which a direction can be inputted. A user tilts the left stick 32 and thereby can input a direction corresponding to the direction of the tilt and input a magnitude corresponding to the angle of the tilt.

The left controller 3 includes various operation buttons. The left controller 3 includes a right direction button 33, a down direction button 34, an up direction button 35, a left direction button 36, a recording button 37, and a “−” (minus) button 47 on the front surface thereof. The left controller 3 includes an L-button 38 and a ZL-button 39 over the upper surface and the left surface thereof. The L-button 38 and the ZL-button 39 may be provided only on the upper surface of the left controller 3 or may be provided only on the left surface of the left controller 3. The left controller 3 includes a button 43 and a button 44 on the protruding portion 40 on the right surface thereof.

The left controller 3 has a mouse sensor opening 70 in the protruding portion 40 on the right surface thereof. The mouse sensor opening 70 is an opening that guides light to the mouse sensor 71 disposed therein. The mouse sensor 71 is, for example, a general mouse sensor (for example, an optical or laser mouse sensor) and acquires data for calculating the movement (movement direction, movement distance, movement speed, etc.), on a work surface, of the left controller 3 positioned such that the right surface thereof (i.e., the upper surface of the protruding portion 40) faces the work surface.

Further, the left controller 3 includes a terminal 72 for the left controller 3 to perform wired communication with the main body apparatus 2, in the protruding portion 40 on the right surface thereof.

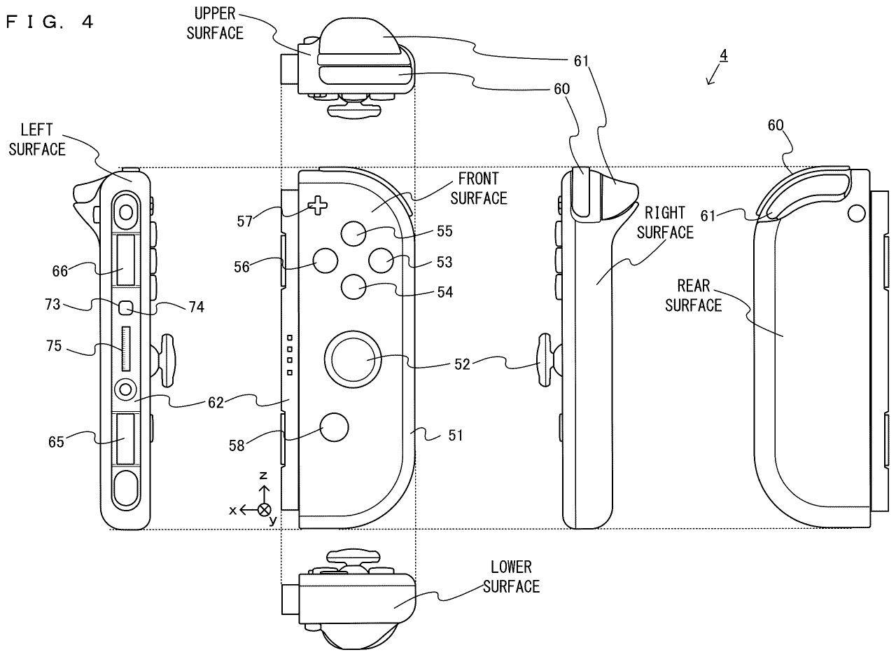

FIG. 4 is six orthogonal views showing an example of the right controller 4. As shown in FIG. 4, the right controller 4 has a vertically long shape, i.e., is shaped to be long in a z-axis direction shown in FIG. 4. The right controller 4 has a protruding portion 62 which is fitted into a recessed portion (not shown) of the main body apparatus 2 in a state where the right controller 4 is attached to the main body apparatus 2. In the state where the right controller 4 is detached from the main body apparatus 2, the right controller 4 can also be held in the orientation in which the right controller 4 is vertically long. The right controller 4 has such a shape and a size that when held in the orientation in which the right controller 4 is vertically long, the right controller 4 can be held with one hand, particularly, the right hand. Further, the right controller 4 can also be held in the orientation in which the right controller 4 is horizontally long. When held in the orientation in which the right controller 4 is horizontally long, the right controller 4 may be held with both hands.

The right controller 4 includes a right analog stick (hereinafter sometimes referred to as a “right stick”) 52 as a direction input section on the front surface thereof. In the exemplary embodiment, the right stick 52 has the same configuration as that of the left stick 32 of the left controller 3. The right controller 4 includes various operation buttons. The right controller 4 includes an A-button 53, a B-button 54, an X-button 55, a Y-button 56, a “+” (plus) button 57, and a home button 58 on the front surface thereof. The right controller 4 includes an R-button 60 and a ZR-button 61 over the upper surface and the right surface thereof. The R-button 60 and the ZR-button 61 may be provided only on the upper surface of the right controller 4 or may be provided only on the right surface of the right controller 4. The right controller 4 includes a button 65 and a button 66 on the protruding portion 62 on the left surface thereof.

The right controller 4 has a mouse sensor opening 73 in the protruding portion 62 on the left surface thereof. The mouse sensor opening 73 is an opening that guides light to a mouse sensor 74 disposed therein. The mouse sensor 74 is, for example, a general mouse sensor (for example, an optical or laser mouse sensor) and acquires data for calculating the movement (movement direction, movement distance, movement speed, etc.), on a work surface, of the right controller 4 positioned such that the left surface thereof (i.e., the upper surface of the protruding portion 62) faces the work surface.

Further, the right controller 4 includes a terminal 75 for the right controller 4 to perform wired communication with the main body apparatus 2, in the protruding portion 62 on the left surface thereof.

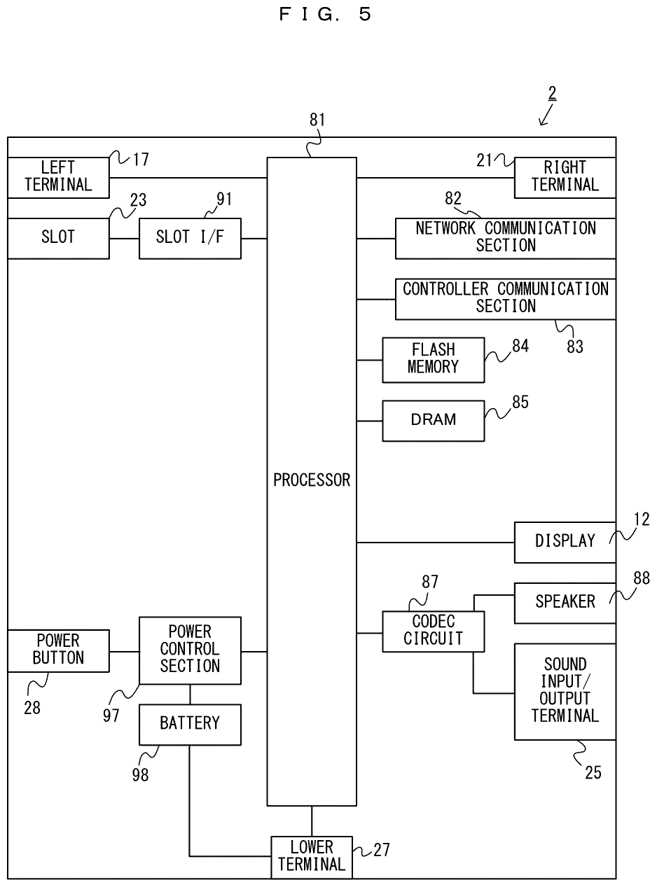

FIG. 5 is a block diagram showing an example of the internal configuration of the main body apparatus 2. The main body apparatus 2 includes a processor 81. The processor 81 is an information processing section for executing various types of information processing to be executed by the main body apparatus 2. For example, the processor 81 may be composed of one or more CPUs (Central Processing Units), or may be composed of a SoC (System-on-a-chip) having a plurality of functions such as a CPU function and a GPU (Graphics Processing Unit) function. The processor 81 executes an information processing program (e.g., a game program) stored in a storage section (specifically, an internal storage medium such as a flash memory 84, an external storage medium attached to a slot 23, or the like), thereby performing the various types of information processing.

The main body apparatus 2 includes the flash memory 84 and a DRAM (Dynamic Random Access Memory) 85 as examples of internal storage media. The flash memory 84 is a memory mainly used to store various data (or programs) to be saved in the main body apparatus 2. The DRAM 85 is a memory used to temporarily store various data used for information processing. The processor 81 appropriately reads and writes data from and to the storage media such as the flash memory 84 and the DRAM 85, thereby performing various kinds of information processing.

The main body apparatus 2 further includes various components as shown in FIG. 5. Hereinafter, the components will be briefly described. A storage medium slot interface (sometimes referred to as “slot I/F”) 91 performs reading/writing of data from/into a predetermined type of storage media (e.g., a dedicated memory card) attached to the slot 23, in response to an instruction from the processor 81. A network communication section 82 performs communication (e.g., Internet communication) with an external device via a network.

A controller communication section 83 performs wireless communication (e.g., communication compliant with the standard of Bluetooth (registered trademark)) with the left controller 3 and/or the right controller 4. A left terminal 17 is a terminal for performing data communication between the processor 81 and the left controller 3. A right terminal 21 is a terminal for performing data communication between the processor 81 and the right controller 4. A lower terminal 27 is a terminal for outputting data (for example, image data, audio data) to a stationary monitor or the like via a cradle when the lower terminal 27 is attached to the cradle.

The display 12 displays an image generated by the processor 81 and/or an externally acquired image. A codec circuit 87 controls input and output of sound data to and from a speaker 88 and a sound input/output terminal 25. A power control section 97 controls supply of power from a battery 98 to each section of the main body apparatus 2 (i.e., each of sections to be supplied with power from the battery 98), based on an instruction from the processor 81, and starts or stops supply of power in response to pressing of a power button 28.

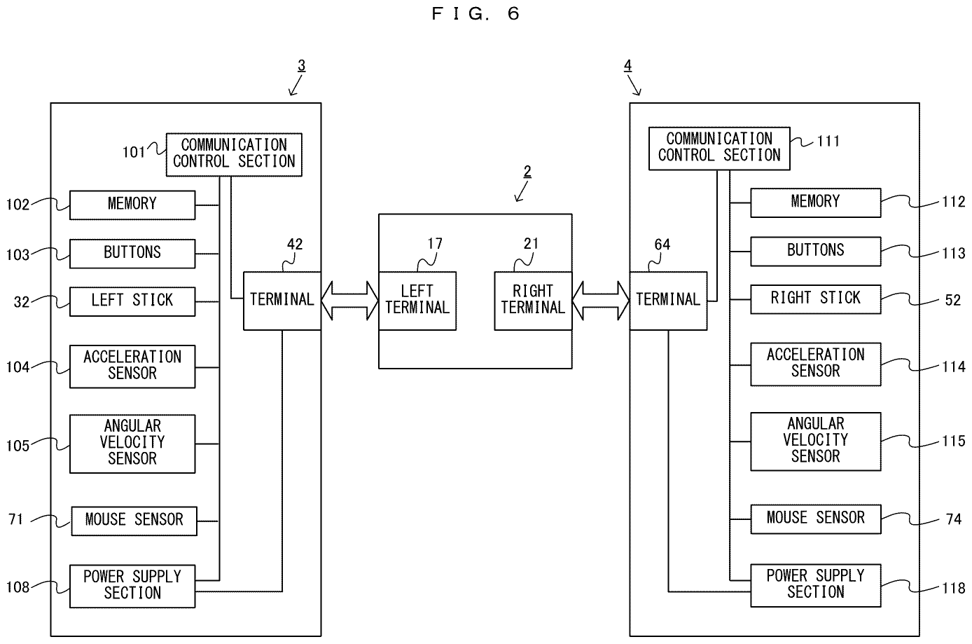

FIG. 6 is a block diagram showing examples of the internal configurations of the main body apparatus 2, the left controller 3, and the right controller 4. The details of the internal configuration of the main body apparatus 2 are shown in FIG. 5 and therefore are omitted in FIG. 6.

The left controller 3 includes a communication control section 101, which communicates with the main body apparatus 2. As shown in FIG. 6, the communication control section 101 is connected to components including a terminal 42. The communication control section 101 communicates with the main body apparatus 2 via the terminal 42 when the left controller 3 is attached to the main body apparatus 2, and the communication control section 101 wirelessly communicates with the main body apparatus 2 when the left controller 3 is detached from the main body apparatus 2.

Further, the left controller 3 includes a memory 102 such as a flash memory. The communication control section 101 includes, for example, a microcomputer (or a microprocessor) and executes firmware stored in the memory 102, thereby performing various processes.

The left controller 3 includes buttons 103 (the right direction button 33, the down direction button 34, the up direction button 35, the left direction button 36, the L-button 38, the ZL-button 39, etc.) and the left stick 32. Each of the buttons 103 and the left stick 32 outputs information regarding an operation performed on itself to the communication control section 101 repeatedly at appropriate timings.

The left controller 3 includes inertial sensors. Specifically, the left controller 3 includes an acceleration sensor 104 and an angular velocity sensor 105. In the exemplary embodiment, the acceleration sensor 104 detects the magnitudes of accelerations along predetermined three axial (e.g., x, y, z axes shown in FIG. 2) directions. The acceleration sensor 104 may detect an acceleration along one axial direction or accelerations along two axial directions. In the exemplary embodiment, the angular velocity sensor 105 detects angular velocities about predetermined three axes (e.g., the x, y, z axes shown in FIG. 2). The angular velocity sensor 105 may detect an angular velocity about one axis or angular velocities about two axes. Each of the acceleration sensor 104 and the angular velocity sensor 105 is connected to the communication control section 101. Then, the detection results of the acceleration sensor 104 and the angular velocity sensor 105 are outputted to the communication control section 101 repeatedly at appropriate timings.

The left controller 3 includes the mouse sensor 71. The mouse sensor 71 acquires data for calculating the movement (movement direction, movement distance, movement speed, etc.) of the left controller 3 on the work surface. Also, using this data, it is possible to determine whether the right surface of the left controller 3 is in contact with the work surface or in a state close to contact with the work surface (for example, a state where the gap between the right surface and the work surface is equal to or less than a predetermined distance (for example, 1 mm)). The data acquired by the mouse sensor 71 is repeatedly outputted to the communication control section 101 at appropriate timings.

The communication control section 101 acquires information regarding an input (specifically, information regarding an operation or the detection result of the sensor) from each of input sections (specifically, the buttons 103, the left stick 32, and the sensors 104, 105, and 71). The communication control section 101 transmits operation data including the acquired information or information obtained by performing predetermined processing on the acquired information, to the main body apparatus 2. The operation data is transmitted repeatedly, once every predetermined time.

The above operation data is transmitted to the main body apparatus 2, whereby the main body apparatus 2 can obtain inputs provided to the left controller 3. That is, the main body apparatus 2 can determine operations on the buttons 103 and the left stick 32 based on the operation data. Further, the main body apparatus 2 can calculate information regarding the motion and/or the orientation of the left controller 3 based on the operation data (specifically, the detection results of the acceleration sensor 104 and the angular velocity sensor 105). Also, the main body apparatus 2 can calculate information regarding mouse operations performed on the left controller 3, based on the operation data (specifically, the detection result of the mouse sensor 71).

The left controller 3 includes an amplifier 106 and a vibrator 107. The amplifier 106 amplifies control signals received from the communication control section 101 and generates drive signals. The vibrator 107 performs vibrating motion in response to the drive signals generated by the amplifier 106 to vibrate the left controller 3. The type of the vibrator 107 is not particularly limited and may be, for example, an eccentric motor, a linear resonant actuator, a voice coil motor (VCM), or the like.

The left controller 3 includes a power supply section 108. The power supply section 108 includes a battery and a power control circuit. The power control circuit is connected to the battery and also connected to components of the left controller 3 (specifically, components that receive power supplied from the battery).

As shown in FIG. 6, the right controller 4 includes a communication control section 111, which communicates with the main body apparatus 2. Further, the right controller 4 includes a memory 112, which is connected to the communication control section 111. The communication control section 111 is connected to components including the terminal 64. The communication control section 111 and the memory 112 have functions similar to those of the communication control section 101 and the memory 102, respectively, of the left controller 3. Thus, the communication control section 111 can communicate with the main body apparatus 2 through both wired communication via the terminal 64 and wireless communication not via the terminal 64 (specifically, communication compliant with the Bluetooth (registered trademark) standard). The communication control section 111 controls the method for communication performed by the right controller 4 with the main body apparatus 2.

The right controller 4 includes input sections similar to the input sections of the left controller 3. Specifically, the right controller 4 includes buttons 113 (the A-button 53, the B-button 54, the X-button 55, the Y-button 56, the R-button 60, the ZR-button 61, etc.), the right stick 52, inertial sensors (an acceleration sensor 114 and an angular velocity sensor 115), and the mouse sensor 74. These input sections have functions similar to those of the input sections of the left controller 3 and operate similarly to the input sections of the left controller 3.

The right controller 4 includes an amplifier 116, a vibrator 117, and a power supply section 118. The amplifier 116, the vibrator 117, and the power supply section 118 have the same functions and operate in the same manner as the amplifier 106, the vibrator 107, and the power supply section 108 of the left controller 3, respectively.

In the exemplary embodiment, each controller can be used as a mouse using the above mouse sensor 71 and mouse sensor 74. In the following, an operation mode in which each controller is not used as a mouse is referred to as first mode, and an operation mode in which each controller is used as a mouse is referred to as second mode.

Switching of the first mode/second mode may be controlled manually or controlled automatically. For example, in the case of switching manually, switching may be performed in accordance with an operation for switching to the first mode/second mode being performed from a predetermined menu or the like. Also, for example, each controller may be provided with a switch for mode switching. Also, for example, in the first mode, a predetermined operation for switching to the second mode (for example, simultaneous pressing of the R-button 60 and the A-button 53, etc.) may be performed to switch from the first mode to the second mode. Also, in the case of switching automatically, for example, the sensor output of each controller may be used. As an example, a configuration that makes it possible to distinguish between a “contact state” where the left surface of the right controller 4/right surface of the left controller 3 is in contact with the work surface and a “separation state” where the left surface of the right controller 4/right surface of the left controller 3 is separated from the work surface, based on the output of each mouse sensor, is provided in advance. Then, for example, in the second mode, when the separation state continues for a fixed period of time or more, the operation mode may be switched to the first mode. Conversely, in the first mode, when the contact state continues for a fixed period of time or more, the operation mode may be switched to the second mode. Also, for example, in the right controller 4 that is in the second mode, when an input to the right stick 52 is performed, the operation mode may be switched to the first mode. The same control may also be performed in the case of the left controller 3. Moreover, for example, when each controller that is in the second mode is attached to the main body apparatus 2, the operation mode may be switched to the first mode. Such modes may be set on each controller side, or may be set by system software or each application on the main body apparatus 2 side in order to interpret, for example, input signals from each controller.

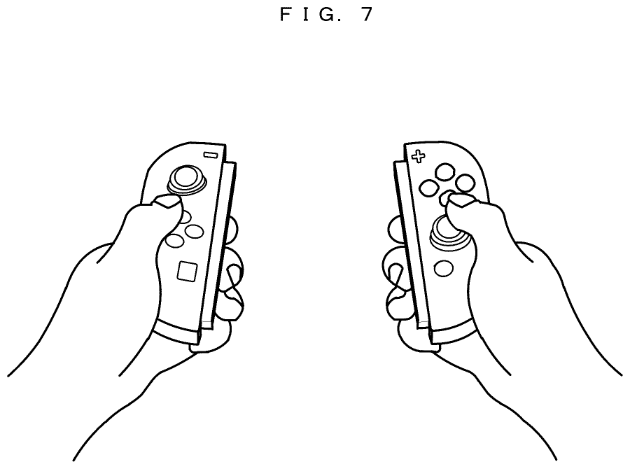

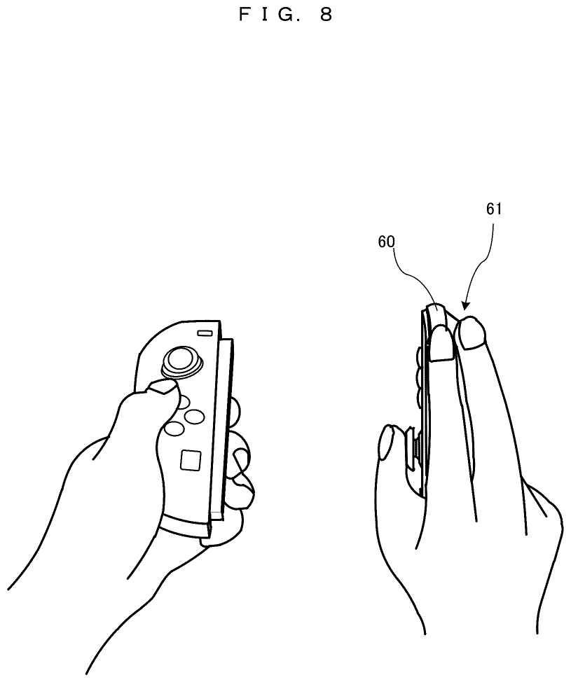

Here, a hand posture (how to hold each controller) when operating each controller, as assumed in the exemplary embodiment, will be described with reference to FIG. 7 and FIG. 8.

FIG. 7 is a schematic diagram showing an example of hand postures when both of the controllers are used in the first mode. FIG. 7 shows that the left controller 3 is operated with the left hand while being grasped and lifted. Similarly, FIG. 7 shows that the right controller 4 is operated with the right hand while being grasped and lifted.

FIG. 8 is a schematic diagram showing an example of hand postures when the left controller 3 is used in the first mode and the right controller 4 is used in the second mode, that is, as a mouse. As shown in FIG. 8, when using the right controller 4 in the second mode, the user is in a posture in which the right hand is placed on the right surface. More specifically, in the example in FIG. 8, the thumb of the right hand of the user is placed on the right stick 52, the index finger of the right hand of the user is placed on the R-button 60, and the middle finger of the right hand of the user is placed on the ZR-button 61. That is, in the case of FIG. 8, the left controller 3 is grasped and lifted, and the right controller 4 is not lifted and is placed on the work surface with the right hand placed thereon. In the following description, “holding the controller” refers to lifting and grasping the controller like the left controller 3 in FIG. 8. Meanwhile, when the right controller 4 is operated with the hand placed thereon such that the surface in which the mouse sensor is provided is in contact with the work surface like the right controller 4 in FIG. 8, this operation is referred to as “mouse operation”. Also, in particular, an operation of moving the right controller 4 on the work surface is referred to as “mouse movement operation”.

Although not shown, both the left controller 3 and the right controller 4 can also be used in the second mode. In this case, a mouse operation is performed on the left controller 3 in a state where the left hand of the user is placed on the left controller 3 in a similar manner to the right hand in the second mode.

### [Outline of Game Processing in Exemplary Embodiment]

Next, the outline of operation of the game processing executed by the game system 1 (hereinafter, may be referred to as “game apparatus 1”) according to the exemplary embodiment will be described. As described above, in the game system 1, the main body apparatus 2 is configured such that each of the left controller 3 and the right controller 4 is attachable thereto and detachable therefrom. In a case of playing the game with the left controller 3 and the right controller 4 attached to the main body apparatus 2, a game image is outputted to the display 12. In a case where the main body apparatus 2 alone with the left controller 3 and the right controller 4 detached therefrom is mounted on the cradle, the main body apparatus 2 can output a game image to a stationary monitor or the like via the cradle. In the exemplary embodiment, the case of playing the game in the latter manner will be described as an example. Specifically, it is assumed that the main body apparatus 2 alone with the left controller 3 and the right controller 4 detached therefrom is mounted on the cradle, and the main body apparatus 2 outputs a game image and the like to a stationary monitor or the like via the cradle. Also, the way of holding each controller and the operation of each controller will be described on the assumption that the left controller 3 is used in the first mode and the right controller 4 is used in the second mode as shown in FIG. 8 above.

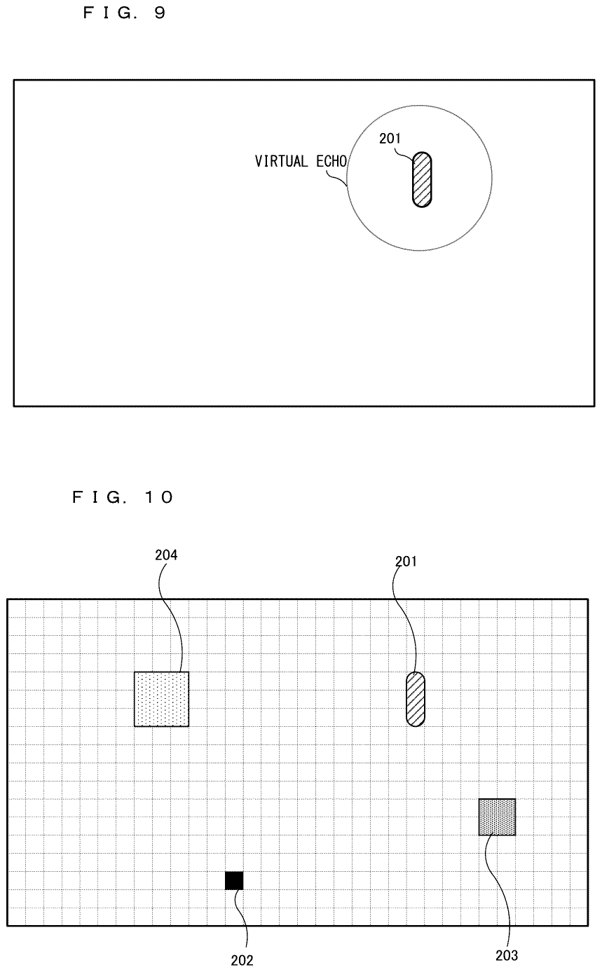

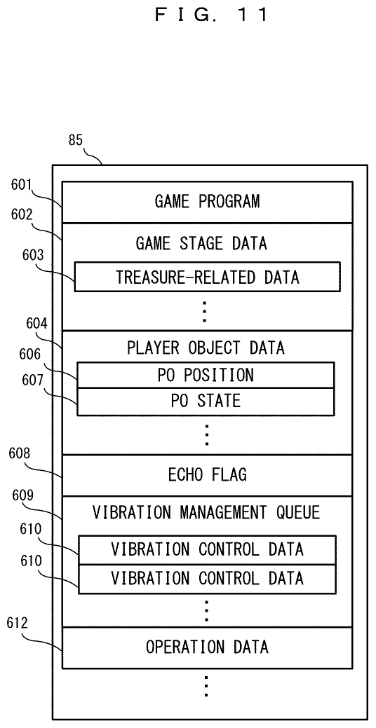

The game assumed in the exemplary embodiment is a treasure hunting game in which “treasures” buried in the ground are searched for. FIG. 9 shows an example of a screen of this game. In FIG. 9, a virtual field (hereafter, simply a field) imitating the ground and a player object (hereinafter referred to as PO) 201 are displayed. In this example, the case where the field is a two-dimensional field will be described as an example. The “treasures” are buried in the field, so that the positions of the “treasures” cannot be visually recognized in terms of appearance. FIG. 10 is a schematic diagram showing an example of the arrangement of “treasures” in the example in FIG. 9. In this example, the case where three “treasures” are buried will be described as an example. In this game, as shown in FIG. 10, the field is divided into invisible squares, and the “treasures” are arranged along these squares. In FIG. 10, a first treasure 202, a second treasure 203, and a third treasure 204 are buried. Here, in this game, for each treasure, a “rank” corresponding to its value is set. In the example in FIG. 10, “A rank” which is the most expensive is set for the first treasure 202. “B rank” which is the next most expensive is set for the second treasure 203, and “C rank” which is the cheapest is set for the third treasure 204. Also, depending on the rank, the size of the treasure (area occupied in the field) also differs. The first treasure 202 has a size of one square, the second treasure 203 has a size of four squares, and the third treasure 204 has a size of nine squares. In the following description, the area on the field where the “treasure” is placed is sometimes referred to as “treasure placement area”.

On the field described above, in this game, the PO 201 can emit a “virtual echo” and can excavate the ground. In this game, various operations for the PO 201 are performed with the right controller 4. Specifically, the PO 201 can be moved by a mouse movement operation, a virtual echo can be emitted with the R-button 60, and excavation actions can be performed with the ZR-button 61. Meanwhile, the left controller 3 is likened and used as a virtual notification device for notifying a result of search by a virtual echo. To describe a specific operation example, first, the PO 201 is moved on the field by a mouse operation on the right controller 4. Then, a circular virtual echo centered on the PO 201 is emitted when the R-button 60 is clicked at a desired position. The virtual echo moves so as to spread in a concentric manner. The buried “treasures” are searched for by this virtual echo. Specifically, when the emitted virtual echo collides with any treasure (on the field plane), the left controller 3 vibrates. Therefore, depending on the distance between the PO 201 and each “treasure”, the time from pressing the R-button 60 until vibration occurs in the left controller 3 varies. That is, the shorter the distance to the “treasure” is, the shorter the time from pressing the R-button 60 until vibration occurs in the left controller 3 is. The user can infer a sense of distance between the PO 201 and the “treasure” by focusing on the time from pressing the R-button 60 until vibration occurs in the left controller 3.

In this game, the intensity of vibration is also made different depending on the rank of the “treasure”. Specifically, control is performed such that a stronger vibration occurs when the rank is higher. Therefore, the user can infer the rank of the buried “treasure” by focusing on the intensity of the vibration.

Also, the user can cause the PO 201 to perform an excavation action by clicking the ZR-button 61. If an excavation action is performed at a position where a “treasure” is buried directly under the PO 201, the “treasure” can be acquired. In addition, if an excavation action is performed at a position where no “treasure” is buried, a message indicating that no “treasure” was buried is displayed.

As described above, this game is a game in which the PO 201 is moved by a mouse operation on the right controller 4, a virtual echo is emitted, and a position where a “treasure” is buried is searched for by relying on vibration occurring in the left controller 3.

By causing the left controller 3 to output vibration based on a result of search by a virtual echo instead of causing the right controller 4 to do so, the user can be allowed to feel “vibration” intended by the game developer, thereby suppressing deterioration of game characteristics. Describing this point, in this game, an operation method using the right controller 4 as a mouse is employed as described above. Therefore, the right controller 4 is basically operated while being in contact with the work surface, but if the right controller 4 is caused to generate vibration in a state where the right controller 4 is in contact with the work surface, there is a possibility that the degree of vibration will change depending on the material of the work surface, etc. For example, vibration felt by the user becomes weaker than expected, etc. That is, there is a possibility that the intensity of vibration, etc., assumed by the developer will not be transmitted well to the user. As a result, in the game in which the user searches for a “treasure” by relying on vibration as described above, there is a possibility that the user cannot make an appropriate guess, which may affect the game characteristics. Therefore, in the exemplary embodiment, by causing the left controller 3, which is grasped (in the above first mode), to output vibration instead of causing the right controller 4, which is in contact with the work surface, to do so, the user is allowed to feel the vibration intended by the developer, thereby suppressing deterioration of the game characteristics. Also, since the right controller 4 on which a mouse operation is performed is not caused to generate vibration, change of the operability of the right controller 4 due to vibration generation can be suppressed.

### [Example of Data to Be Used]

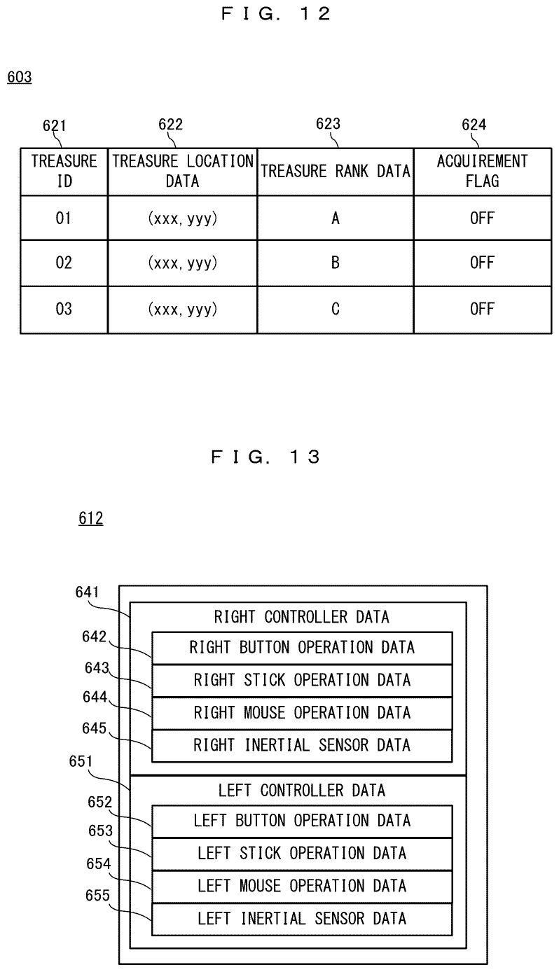

Next, various data used in the processing in the exemplary embodiment will be described. FIG. 11 is a memory map showing an example of various data stored in the DRAM 85 of the main body apparatus 2. In the DRAM 85, a game program 601, game stage data 602, player object data 604, an echo flag 608, a vibration management queue 609, operation data 612, etc., are stored.

The game program 601 is a program for performing the game processing according to the exemplary embodiment.

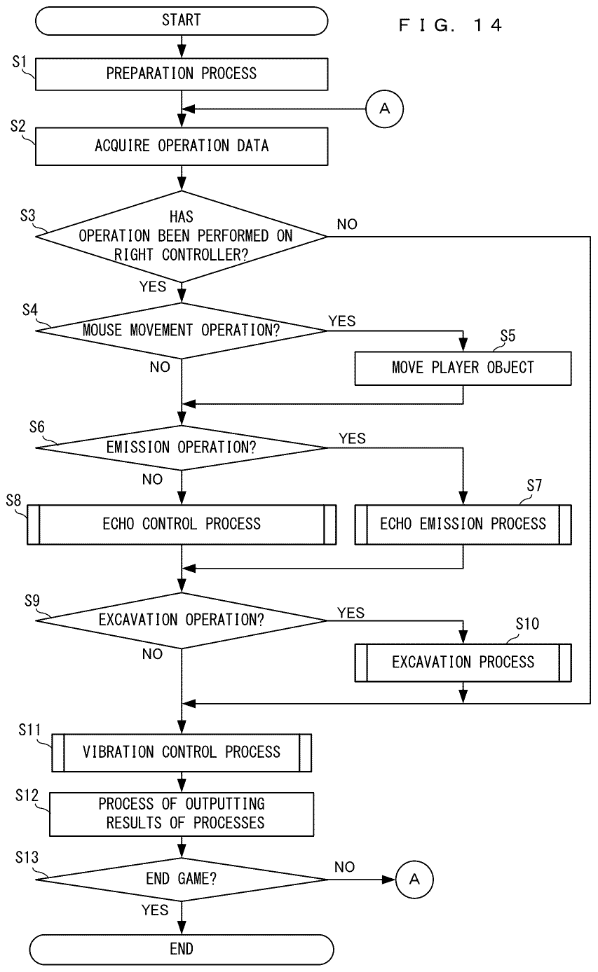

The game stage data 602 is data regarding the field described above. The game stage data 602 includes at least treasure-related data 603. FIG. 12 shows an example of the data structure of the treasure-related data 603. The treasure-related data 603 is data in a table format including at least items such as a treasure ID 621, treasure location data 622, treasure rank data 623, and an acquirement flag 624. The treasure ID 621 is an identifier for uniquely identifying that “treasure”. The treasure location data 622 is data indicating the position (area) where the “treasure” is buried in the above field. The treasure rank data 623 indicates the rank of the “treasure”. The acquirement flag 624 is a flag indicating whether or not the “treasure” has already been acquired, and when the acquirement flag 624 is OFF, it indicates that the “treasure” has not yet been acquired.

Referring back to FIG. 11, the player object data 604 is data regarding the above PO 201. The player object data 604 includes at least a PO position 606 and a PO state 607. The PO position 606 is data indicating the current position of the PO 201 on the field. The PO state 607 is data indicating the current state of the PO 201. For example, data indicating that the PO 201 is moving, that the PO 201 is performing an excavation action, or the like is set as appropriate.

The echo flag 608 is a flag indicating whether or not a virtual echo currently exists. The echo flag 608 is initially OFF, and when the echo flag 608 is ON, it indicates that a virtual echo currently exists.

The vibration management queue 609 can include vibration control data 610 to reproduce vibration. The vibration control data 610 is data defining the content of vibrating the left controller 3. For example, the vibration control data 610 is data indicating the amplitude, frequency, and cycle of vibration. Also, the vibration control data 610 may be data indicating electrical parameters such as a voltage value for realizing intended vibration. Also, the vibration control data 610 may be, for example, data specifying a preset to be used among preset amplitude/frequency data. In the exemplary embodiment, the vibration of the left controller 3 is controlled based on the vibration control data 610 registered in the vibration management queue 609. In addition, when reproduction of vibration related to each vibration control data 610 is completed, the vibration control data 610 is deleted from the vibration management queue 609.

The operation data 612 is data for indicating the contents of operations performed on the above controller. FIG. 13 shows an example of the data structure of the operation data 612. The operation data 612 includes right controller data 641 and left controller data 651.

The right controller data 641 includes right button operation data 642, right stick operation data 643, right mouse operation data 644, and right inertial sensor data 645. The right button operation data 642 is data indicating the pressed state of each button 113 of the right controller 4. The right stick operation data 643 is data indicating the input direction, input amount, etc., of the right stick 52. The right mouse operation data 644 is data indicating the detection result of the mouse sensor 74 of the right controller 4. The right mouse operation data 644 may be, for example, data indicating the amounts of movement in the x axis and the y axis, or position coordinates (x, y) on a virtual mouse plane. The right inertial sensor data 645 is data indicating the detection results of the acceleration sensor 114 and the angular velocity sensor 115. For example, the right inertial sensor data 645 may be 3-axis acceleration data or angular velocity data.

The left controller data 651 includes left button operation data 652, left stick operation data 653, left mouse operation data 654, and left inertial sensor data 655. The left button operation data 652 is data indicating the pressed state of each button 103 of the left controller 3. The left stick operation data 653 is data indicating the input direction, input amount, etc., of the left stick 32. The left mouse operation data 654 is data indicating the detection result of the mouse sensor 71 of the left controller 3. The left inertial sensor data 655 is data indicating the detection results of the acceleration sensor 104 and the angular velocity sensor 105.

### [Example of Flowcharts]

Next, an example of flowcharts of the game processing will be described. In the exemplary embodiment, flowcharts described below are realized by one or more processors reading and executing a program stored in one or more memories. These flowcharts are merely an example of the processing. Therefore, the order of each process step may be changed as long as the same result is obtained. In addition, the values of variables and thresholds used in determination steps are also merely examples, and other values may be used as necessary.

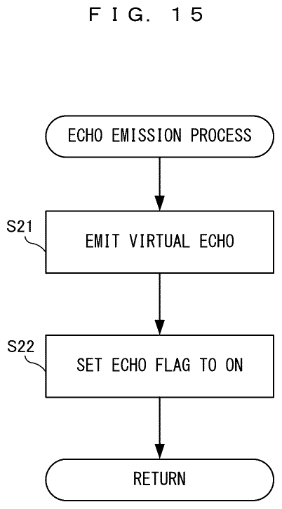

FIG. 14 is a flowchart showing the details of an example of the game processing according to the exemplary embodiment. A process loop of step S1 to step S13 in FIG. 14 is repeated multiple times per second according to a frame rate.

When the game processing is started, the processor 81 first performs a preparation process in step S1. In this process, first, the field in which the “treasures” are placed is generated based on the game stage data 602. Then, the PO 201 is placed at a position, on the field, which is set as an initial placement position. Furthermore, guidance images and sounds (not shown) indicating how to hold each controller as shown in FIG. 8 above are presented to the user. In response to this guidance, the user performs a predetermined operation indicating that preparation of the operation method as shown in FIG. 8 has been completed, and as a result, a game screen is displayed, actual game play is started, and the processor 81 advances the processing to step S2.

Next, in step S2, the processor 81 acquires the operation data 612.

Next, in step S3, the processor 81 determines whether or not any operation has been performed on the right controller 4, based on the operation data 612. If, as a result of this determination, no operation has been performed on the right controller 4 (NO in step S3), the processor 81 advances the processing to step S11 described later.

On the other hand, if an operation has been performed on the right controller 4 (YES in step S3), in step S4, the processor 81 determines whether or not a mouse movement operation of moving the right controller 4 that is in the second mode has been performed, based on the right mouse operation data 644. If, as a result of this determination, the mouse movement operation has been performed (YES in step S4), in step S5, the processor 81 controls the movement of the PO 201 based on the right mouse operation data 644. Then, the processor 81 advances the processing to step S6. On the other hand, if the mouse movement operation has not been performed, the process in step S5 above is skipped.

Next, in step S6, the processor 81 determines whether or not an emission operation for emitting the above virtual echo (clicking of the R-button 60) has been performed, based on the right button operation data 642. If, as a result of this determination, the emission operation has been performed (YES in step S6), the processor 81 executes an echo emission process in step S7.

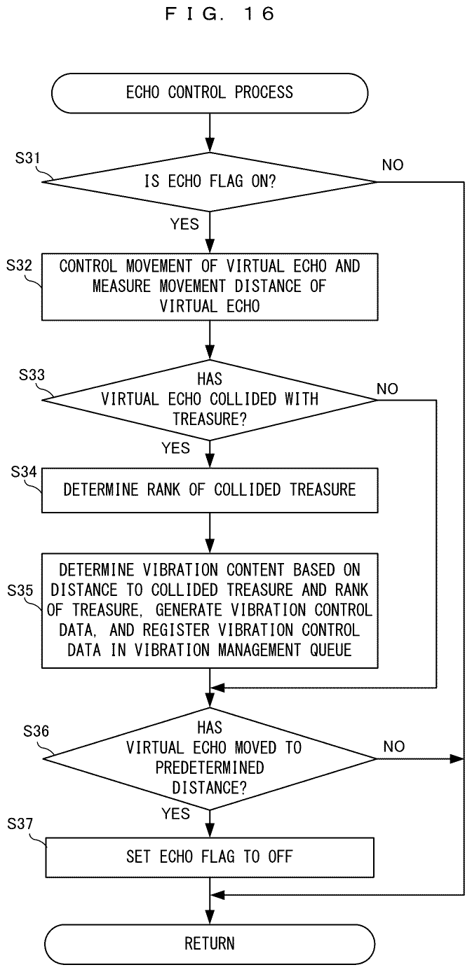

FIG. 15 is a flowchart showing the details of the above echo emission process. First, in step S21, the processor 81 generates a virtual echo and starts moving the virtual echo. Also, along with this, the processor 81 starts measuring the movement distance of the virtual echo. Furthermore, in step S22, the processor 81 sets the echo flag 608 to ON. Thus, the echo emission process ends.

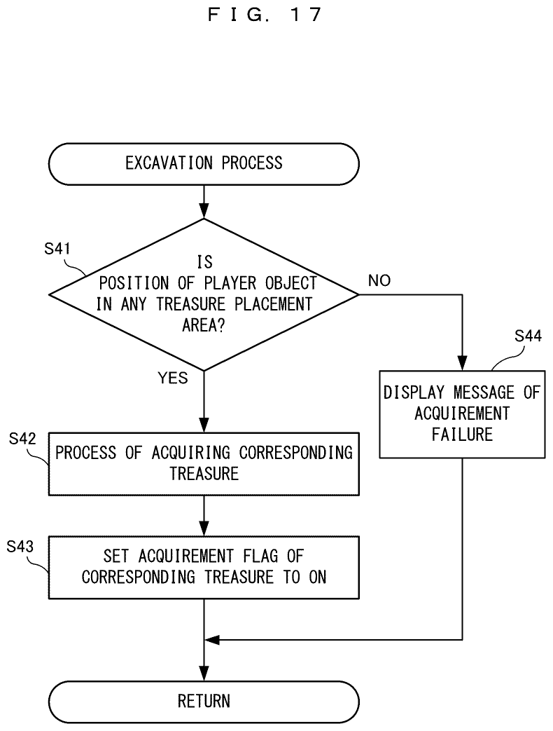

Referring back to FIG. 14, if, as a result of the determination in step S6 above, the emission operation has not been performed (NO in step S6), the processor 81 executes an echo control process in step S8. FIG. 16 is a flowchart showing the details of this echo control process. First, in step S31, the processor 81 determines whether or not the echo flag 608 is ON. If the echo flag 608 is OFF (NO in step S31), the processor 81 ends the echo control process. If the echo flag 608 is ON (YES in step S31), in step S32, the processor 81 moves the virtual echo by a predetermined distance (moves the virtual echo such that the virtual echo spreads in a concentric manner). In addition, the processor 81 also continues to measure the movement distance (length of the radius) of the virtual echo.

Next, in step S33, the processor 81 determines whether or not the virtual echo has collided with any of the “treasures” for each of which the acquirement flag 624 is OFF, that is, the placement position of an unacquired “treasure” and the position of an outer peripheral portion of the virtual echo overlap. If, as a result of this determination, the virtual echo has not collided with any of the “treasures” (NO in step S33), the processor 81 advances the processing to step S36 described later. If the virtual echo has collided with any of the “treasures” (YES in step S33), in step S34, the processor 81 determines the rank of the collided “treasure” based on the treasure-related data 603.

Next, in step S35, the processor 81 generates vibration control data 610 indicating a vibration content (vibration timing, amplitude, cycle, etc.) based on the distance from the PO 201 to the collided “treasure” and the rank of the “treasure” and registers the vibration control data 610 in the vibration management queue 609. At this time, if the virtual echo has collided with a plurality of “treasures” at the same time, vibration control data 610 is generated for each “treasure”.

Next, in step S36, the processor 81 determines whether or not the emitted virtual echo has moved to a predetermined distance. If, as a result of this determination, the virtual echo has moved to the predetermined distance (YES in step S36), in step S37, the processor 81 sets the echo flag 608 to OFF. That is, if the virtual echo spreads to the predetermined distance, a process of deleting the virtual echo is performed. On the other hand, if the virtual echo has not moved to the predetermined distance (NO in step S36), the process in step S37 above is skipped. Thus, the echo control process ends.

Referring back to FIG. 14, next, in step S9, the processor 81 determines whether or not an excavation operation (clicking of the ZR-button 61) has been performed. If, as a result of this determination, the excavation operation has not been performed (NO in step S9), the processor 81 advances the processing to step S11 described later. If the excavation operation has been performed (YES in step S9), the processor 81 executes an excavation process in step S10.

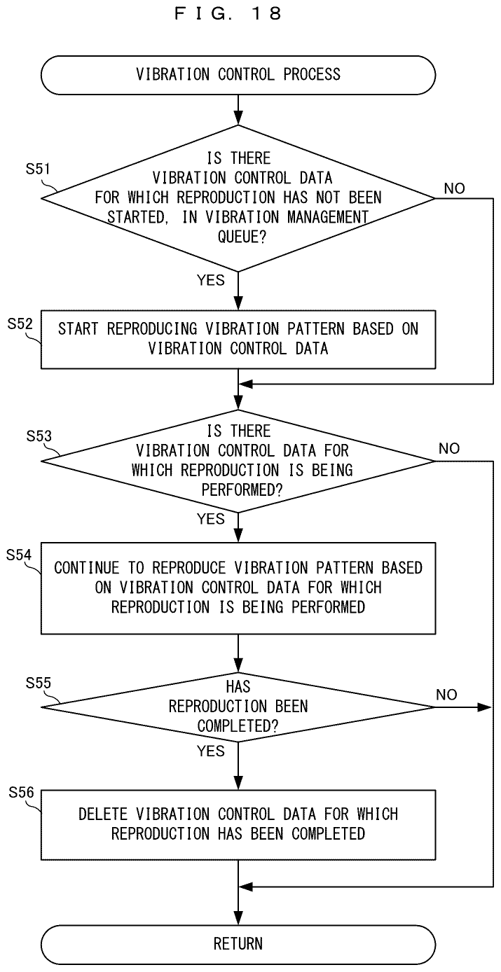

FIG. 17 is a flowchart showing the details of the above excavation process. First, in step S41, the processor 81 determines whether or not the current position of the PO 201 is included in the above treasure placement area corresponding to an unacquired “treasure”. If, as a result of this determination, the current position of the PO 201 is included in the treasure placement area (YES in step S41), in step S42, the processor 81 executes a process of causing the PO 201 to perform an excavation action and also acquiring the corresponding “treasure”. For example, a process of giving the “treasure” to the PO 201 as an owned item, a process of adding points corresponding to the rank of the “treasure”, etc., are executed.

Next, in step S43, the processor 81 sets the acquirement flag 624 corresponding to the acquired “treasure” to ON. Then, the excavation process ends.

On the other hand, if, as a result of the determination in step S41 above, the current position of the PO 201 is not included in the treasure placement area (NO in step S41), in step S44, the processor 81 executes a process of causing the PO 201 to perform an excavation action and then displaying a message indicating that the “treasure” could not be acquired. Then, the excavation process ends.

Referring back to FIG. 14, next, in step S11, the processor 81 executes a vibration control process. FIG. 18 is a flowchart showing the details of the vibration control process. First, in step S51, the processor 81 determines whether or not there is vibration control data 610 for which reproduction has not yet been started, in the vibration management queue 609. If, as a result of this determination, there is such vibration control data 610 (YES in step S51), in step S52, the processor 81 starts reproducing vibration based on the vibration control data 610 for which reproduction has not yet been performed. On the other hand, if there is no such vibration control data 610 (NO in step S51), the process in step S52 is skipped.

Next, in step S53, the processor 81 determines whether or not there is vibration control data 610 for which reproduction is being performed. If, as a result of this determination, there is no vibration control data 610 for which reproduction is being performed (NO in step S53), the processor 81 ends the vibration control process. On the other hand, if there is vibration control data 610 for which reproduction is being performed (YES in step S53), in step S54, the processor 81 continues to reproduce vibration based on the vibration control data 610 for which reproduction is being performed. Next, in step S55, the processor 81 determines whether or not there is vibration control data 610 for which reproduction has been completed. If, as a result of this determination, there is such vibration control data 610 (YES in step S55), in step S56, the processor 81 deletes the vibration control data 610 for which reproduction has been completed, from the vibration management queue 609. On the other hand, if there is no vibration control data 610 for which reproduction has been completed (NO in step S55), the process in step S56 is skipped. Thus, the vibration control process ends.

Referring back to FIG. 14, next, in step S12, the processor 81 executes a process of outputting the results of the various processes described above. That is, a process of outputting a game image and a game sound reflecting the various processes described above to a stationary monitor and a process of outputting a vibration reproduction signal based on the above vibration control data 610 to the left controller 3 are executed.

Next, in step S13, the processor 81 determines whether or not a condition for ending the game processing has been satisfied. If the condition has not been satisfied (NO in step S13), the processor 81 returns to step S2 above and repeats the processing. If the condition has been satisfied (YES in step S13), the game processing ends.

### [Modifications]

Next, some modifications will be described. In the above embodiment, the example in which the movement of the PO 201 is controlled based on a mouse movement operation on the right controller 4 in the second mode has been described. In another exemplary embodiment, for moving the PO 201, a movement operation on the right controller 4 switched to the first mode may also be used. When performing a movement operation on the right controller 4 in the first mode, the PO 201 may be moved with the right stick 52, for example. Also, when performing a movement operation for the PO 201 based on an operation on the right stick 52, the right controller 4 may be caused to output vibration regarding the virtual echo. When operating the right controller 4 in the first mode as shown in FIG. 7 above, since the right controller 4 is not in contact with the work surface, even if the right controller 4 is caused to output vibration, the user can be allowed to appropriately feel the vibration intended by the developer.

When vibrating the right controller 4, the vibration control data 610 outputted to the left controller 3 in the above processing may be used as it is, vibration control data prepared in advance for the right controller 4 may be used, or data obtained by processing the vibration control data 610 such that, for example, the magnitude of vibration is made smaller or larger may be used as data for vibrating the right controller 4.

When the right controller 4 is operated while being switched between the first mode and the second mode as described above, the right controller 4 may be caused to output vibration when the right controller 4 is switched to the first mode, as described above, or even when the right controller 4 is switched to the first mode, the left controller 3 may still be caused to output vibration. For example, when, depending on the content of the game, there is a possibility that the user will be confused when the vibrating controller becomes the right controller 4 or the left controller 3, the left controller 3 may be fixedly caused to output vibration regardless of whether the right controller 4 is in the first mode or the second mode.

The above processing may be applied to a game in which control of switching between the first mode and the second mode as described above is not performed. For example, the above-described processing may be applied to a game in which the method for operating the left controller 3 is fixed to the above operation method in the first mode and the method for operating the right controller 4 is fixed to the above operation method in the second mode.

The determination as to whether the controller is in contact with the work surface or in a state close to contact with the work surface may be executed by the main body apparatus 2. Such determination may be executed by system software of the main body apparatus 2 or may be executed by a game application. Determination as to the controller state that is necessary for switching between the first mode and the second mode may be executed as appropriate in addition to or instead of the above, and this determination may be executed by the controller, the main body apparatus, or both.

Also, as another example of the above case of performing a movement operation on the right controller 4 in the first mode, the movement of the PO 201 may be controlled based on the output of the acceleration sensor 114 or the angular velocity sensor 115. Even in this case, the right controller 4 may be caused to output vibration regarding the virtual echo. In this case as well, the user can be allowed to appropriately feel the vibration intended by the developer.

Also, as another example of the operation manner, for example, when the controller is used in a state of being attached to the main body apparatus 2 as shown in FIG. 1 above, both left and right controllers may be caused to output the vibration described above. In addition to the manner shown in FIG. 1, for example, a manner in which each controller is fixed to a predetermined peripheral device and used as an integrated controller is also conceivable. In this case as well, similarly, both left and right controllers may be caused to output the vibration described above. Also, when the left controller 3 and the right controller 4 are directly or indirectly fixed to each other and used, for example, the movement of the PO 201 may be controlled using the left stick 32 as a direction input section. For the above vibration regarding the virtual echo, the same vibration control data 610 may be outputted to each of the left and right controllers. By causing both of the left and right controllers to output vibration when the left and right controllers are integrated and used as described above, a feeling of strangeness that is provided when vibration is felt from only one controller can be reduced. In addition, in such a case, both controllers may be caused to output the same vibration pattern, or the left and right controllers may be vibrated in different vibration patterns. Even when the left and right controllers are not directly or are indirectly fixed to each other, the same control may be possible.

Also, in the treasure hunting game described above, the virtual field may be a two-dimensional field or a three-dimensional field. Also, the virtual field may be a one-dimensional field.

Also, in the above example, the example in which vibration is started when the virtual echo collides with a “treasure” has been described. The present disclosure is not limited thereto, and in another exemplary embodiment, vibration may be determined based on the positional relationship between the PO 201 and a “treasure”. For example, the timing for starting vibration may be determined based on the linear distance between the PO 201 and a “treasure”.

Also, in another example, vibration may be determined based on another element regarding the PO 201 instead of the “position” of the PO 201. For example, when the state of the PO 201 changes from a first state to a second state based on a mouse movement operation on the right controller 4, vibration corresponding to the second state may be determined and the above vibration control data may be generated. The “state” may include a search state, an invincible state, a defensive state, a weakened state, an attack state, a flight state, etc. When the PO 201 is in the first state, vibration may or may not be generated. The first state and the second state can be said to be states in which generated vibrations are different.

Also, the left controller 3 may be used for game operation. For example, the movement of the PO 201 may be controlled by an operation on the left stick 32 of the left controller 3 in the first mode, and a movable pointer may be operable with the right controller 4 in the second mode. In this case, a mouse operation may be performed for the pointer, the above virtual echo may be emitted with the R-button 60 such that the position of the pointer is set as a center, and the left controller 3 may be caused to output vibration according to the result. Then, the PO 201 may be moved with the left stick 32 and caused to dig at the position of the PO 201.

In addition, a “treasure” buried in the ground may be configured to emit pulses at regular intervals, and when the PO 201 touches the pulse, the left controller 3 may be vibrated. Moreover, the cycle of the emitted pulses may be different depending on the range of the “treasure”. Furthermore, the magnitude of vibration may be set according to the distance between the position of the pointer and the “treasure”.

In addition, the above-described processing may be applied to games in which, instead of the “treasures”, the location or position of something is guessed based on vibration.

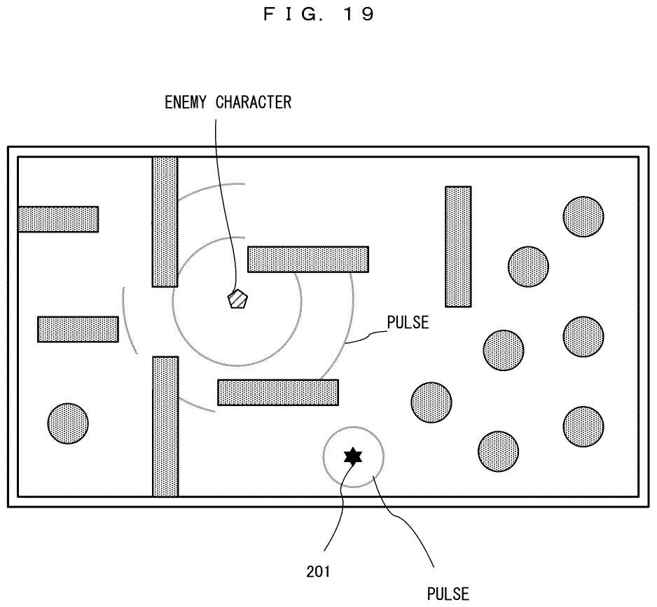

Also, the treasure hunting game described above is an example, and even in another game, a controller that is not a controller on which a mouse operation is being performed may be vibrated. For example, the above-described processing can be applied to game processing described below. For example, the above-described processing may be applied to competitive game processing in which a player character and an enemy character can emit circular “pulses” to each other and can give damage to the opponent by causing such a “pulse” to hit the opponent. FIG. 19 shows an example of a screen of such a competitive game. In FIG. 19, a PO 201, an enemy character, and multiple obstacle objects (shown as shaded circular and rectangular objects in FIG. 19) exist on a virtual field. As an operation example, the PO 201 can be moved by performing a mouse movement operation on the right controller 4 in the second mode, and “pulses” can be emitted with the R-button 60, as in the above embodiment. Also, the “pulses” are configured to be blocked by the obstacle objects. That is, this game is a game in which a “pulse” is caused to hit the enemy character while moving the PO 201 such that the PO 201 hides behind an obstacle object. When a “pulse” hits the enemy character, the left controller 3 may be caused to output vibration as in the above.

Also, for example, in a first-person shooter game (FPS: first-person shooter), an aim sight may be operated by performing a mouse movement operation on the right controller 4, shooting may be performed with the R-button 60, and control in which the left controller 3 is caused to output vibration when a bullet hits may be performed. Also, at this time, the content of the vibration may be changed according to an object against which the bullet has hit. Accordingly, the vibration of the left controller 3 can allow the user to grasp the result of shooting through bodily sensation without decreasing the operability with the right controller 4.

Also, the above processing can be applied to a competitive game in which an element that “hides” something is used. For example, the above processing may be applied to game processing in which one user hides a treasure on a field as described above, and another user searches for the treasure. In particular, in this case, the above processing may be applied to the controller of the user who “hides” the treasure. For example, the PO 201 may be moved on the field by a mouse operation on the right controller 4, and a process of “hiding” the treasure at the position where the PO 201 is located may be performed through clicking the R-button 60. Then, at this time, in order to inform the user that the operation of hiding the treasure was successful, the left controller 3 may be vibrated. If the right controller 4 is vibrated, there is a possibility that a vibration sound will be generated via the work surface and the opponent will notice that the “treasure” is hidden at that position. However, by causing the left controller 3 to output vibration, the “treasure” can be hidden without being noticed by the opponent.

The above processing may be applied to a game in which, for example, an item that attacks another player object when the other player object passes over the item is hidden instead of the “treasure”. In this case as well, by vibrating the left controller 3, the hidden position can be prevented from being noticed by the opponent, and the game characteristics can be maintained.

In addition, the above processing may be applied to game processing described below. For example, the above processing may be applied to a “medical examination game” in which the right controller 4 is likened as a “chest piece” of a “stethoscope” and a mouse operation is performed thereon. In this case, the left controller 3 may be positioned near an ear of the user. Then, a virtual chest piece may be operated with the right controller 4, and predetermined vibration such as “heart sound” corresponding to the position of the virtual chest piece may be reproduced.

Also, vibration accompanied by sound felt by hearing may be generated instead of or in addition to vibration felt by touch.

Also, for example, the above processing may be applied to game processing in which the left controller 3 is likened as a “shield” and play is performed. For example, a game in which the PO 201 advances while dodging enemy attacks is assumed. The PO 201 may be automatically moved forward, may be moved in the left-right direction by a mouse operation on the right controller 4, and may be caused to perform an action of “holding up the shield” by clicking the R-button 60. Then, if defense against an enemy attack is successful, the left controller 3 may be vibrated.

Also, in the above embodiment, the case where the above processing is executed by the information processing apparatus alone has been described. The information processing apparatus may include a plurality of storages and a plurality of processors. The above processing may be shared and executed by these storages and processors. Also, this information body apparatus may be a server, and the above processing may be executed in a distributed system composed of a plurality of information processing apparatuses including this server.

Also, in another exemplary embodiment, the main body apparatus 2 may be, for example, an information processing apparatus such as a smartphone, a tablet terminal, a personal computer, or a wearable terminal. In addition, the main body apparatus 2 may be configured without the display 12. Moreover, the processor 81 may be a general-purpose processor or a dedicated processor, and may be in any form such as so-called SoC, CPU, ASIC, or microcomputer.

Also, the configuration of the controller is an example, and the shape of the controller is not limited to the above shape and may be another shape. Moreover, the controller may be a controller that is not detachable from the main body apparatus 2. In addition, the types and numbers of various input sections are also not limited to the above. For example, only one of the two controllers may be provided with a mouse sensor. Only one of the two controllers may be provided with a stick. The controller does not have to be a set of two.

While the present disclosure has been described in detail, the foregoing description is in all aspects illustrative and not restrictive. It is to be understood that numerous other modifications and variations can be devised without departing from the scope of the present disclosure.

What is claimed is:

1. A computer-implemented method comprising:
acquiring, from a first controller on which a mouse operation is performed by one hand of a user and which includes a first mouse sensor and a first vibration device, first data based on output of the first mouse sensor;
controlling a position of a virtual object, based on the first data;
generating second data, based on the position of the virtual object; and
vibrating a second vibration device of a second controller which is held by another hand of the user and includes the second vibration device, based on the second data.

2. The computer-implemented method according to claim 1, further comprising:
acquiring third data based on output of a first direction input section which the first controller includes and which is configured to be operated by the user;
controlling the position of the virtual object, based on the third data;
generating fourth data, based on the position of the virtual object, at least while the virtual object is controlled based on the third data; and
vibrating the first vibration device, based on the fourth data.

3. The computer-implemented method according to claim 1, further comprising:
acquiring fifth data based on output of an inertial sensor which the first controller includes;
controlling the position of the virtual object, based on the fifth data;
generating sixth data, based on the position of the virtual object, at least while the virtual object is controlled based on the fifth data; and
vibrating the first vibration device, based on the sixth data.

4. The computer-implemented method according to claim 1, further comprising:
acquiring seventh data based on output of a second direction input section which the first controller or the second controller includes and which is configured to be operated by the user;
at least while the first controller and the second controller are directly or indirectly fixed to each other, controlling the position of the virtual object, based on the seventh data, and generating eighth data, based on the position of the virtual object; and
vibrating the first vibration device and the second vibration device, based on the eighth data.

5. The computer-implemented method according to claim 1, further comprising generating the second data, based on a positional relationship between the virtual object and a first position.

6. The computer-implemented method according to claim 1, further comprising vibrating the second vibration device at a timing corresponding to a positional relationship between the virtual object and a first position.

7. The computer-implemented method according to claim 6, wherein
there is a second position different from the first position,
attribute information associated with each of the first position and the second position is set, and
the computer-implemented method further comprises generating the second data such that the second vibration device is vibrated in a manner corresponding to the attribute information.

8. The computer-implemented method according to claim 6, further comprising generating the second data such that the second vibration device is vibrated in a manner corresponding to a positional relationship between the virtual object and the first position.

9. The computer-implemented method according to claim 6, further comprising:
acquiring ninth data based on output of a third direction input section or a second button which the second controller includes and which is operated by the user; and
performing predetermined game processing, based on the ninth data.

10. An information processing system comprising:
a first controller configured to be operated through a mouse operation by one hand of a user, the first controller comprising a first mouse sensor, a first vibration device, and a first transmitter configured to transmit first data based on an output of the first mouse sensor;
a device comprising a device receiver, a device transmitter, one or more processor, and one or more memory storing instructions that, when executed, perform game processing comprising
controlling a position of a virtual object based on the first data received by the device receiver, and
generating second data based on the position of the virtual object, the second data being configured to be transmitted by the device transmitter; and
a second controller configured to be held by another hand of the user, the second controller comprising a second mouse sensor, a second vibration device, and a second receiver configured to receive the second data, wherein
the second vibration device is vibrated based on the second data received by the second receiver.

11. One or more non-transitory computer-readable storage media having stored therein instructions that, when executed, cause one or more processors to perform game processing comprising:
acquiring, from a first controller on which a mouse operation is performed by one hand of a user and which includes a first mouse sensor and a first vibration device, first data based on output of the first mouse sensor;
controlling a position of a virtual object, based on the first data;
generating second data, based on the position of the virtual object; and
vibrating a second vibration device of a second controller which is held by another hand of the user and includes the second vibration device, based on the second data.

12. The non-transitory computer-readable storage media according to claim 11, wherein the game processing further comprises:
acquiring third data based on output of a first direction input section which the first controller includes and which is configured to be operated by the user;
controlling the position of the virtual object, based on the third data;
generating fourth data, based on the position of the virtual object, at least while the virtual object is controlled based on the third data; and
vibrating the first vibration device, based on the fourth data.

13. The non-transitory computer-readable storage media according to claim 11, wherein the game processing further comprises:
acquiring fifth data based on output of an inertial sensor which the first controller includes;
controlling the position of the virtual object, based on the fifth data;
generating sixth data, based on the position of the virtual object, at least while the virtual object is controlled based on the fifth data; and
vibrating the first vibration device, based on the sixth data.

14. The one or more non-transitory computer-readable storage media according to claim 11, wherein the game processing further comprises:
acquiring seventh data based on output of a second direction input section which the first controller or the second controller includes and which is configured to be operated by the user;
at least while the first controller and the second controller are directly or indirectly fixed to each other, controlling the position of the virtual object, based on the seventh data, and generating eighth data, based on the position of the virtual object; and
vibrating the first vibration device and the second vibration device, based on the eighth data.

15. The one or more non-transitory computer-readable storage media according to claim 11, wherein the game processing further comprises generating the second data, based on a positional relationship between the virtual object and a first position.

16. The one or more non-transitory computer-readable storage media according to claim 11, wherein the game processing further comprises vibrating the second vibration device at a timing corresponding to a positional relationship between the virtual object and a first position.

17. The non-transitory computer-readable storage media according to claim 16, wherein
there is a second position different from the first position,
attribute information associated with each of the first position and the second position is set, and
the game processing further comprises generating the second data such that the second vibration device is vibrated in a manner corresponding to the attribute information.

18. The non-transitory computer-readable storage media according to claim 16, wherein the game processing further comprises generating the second data such that the second vibration device is vibrated in a manner corresponding to a positional relationship between the virtual object and the first position.

19. The non-transitory computer-readable storage media according to claim 16, wherein the game processing further comprises:
acquiring ninth data based on output of a third direction input section or a second button which the second controller includes and which is operated by the user; and
performing predetermined game processing, based on the ninth data.
